(19) United States
(12) Patent Application Publication
(10) Pub. No.: US 2026/0162326 A1
(43) Pub. Date: Jun. 11, 2026

(54) EFFECTS GENERATION MODEL

(71) Applicant: Lemon Inc., Grand Cayman (KY)

(72) Inventors: Lexin Tang, Los Angeles, CA (US); Yulei Niu, Los Angeles, CA (US); Jie Meng, Los Angeles, CA (US); Xiaocheng Tang, Los Angeles, CA (US); Blake Garrett Fuselier, Los Angeles, CA (US); Runjia Tian, Los Angeles, CA (US)

(21) Appl. No.: 18/976,227

(22) Filed: Dec. 10, 2024

(51) Int. Cl. G06T 11/60; G06F 40/40; G06T 11/00

(52) U.S. Cl. CPC G06T 11/60; G06T 11/10; G06F 40/40; G06T 2200/24

(57) ABSTRACT

A computing system receives a user query, generates a plurality of action descriptions based on the user query, generates domain-specific language instructions based on the plurality of action descriptions, selects a set of modular subgraphs from a library of a plurality of modular subgraphs based on the domain-specific language instructions, assembles the set of modular subgraphs into a package by interconnecting the set of modular subgraphs, and generates a visual effect by executing the package.

### BACKGROUND

Visual effects are the creation, manipulation, or enhancement of imagery using digital tools to achieve a desired visual result. These effects are used to engage audiences across various applications in entertainment and media. In social media applications, visual effects such as animations, color transformations, filters, overlays, text stylizations, and dynamic transitions provide a creative and interactive way for users to personalize their content.

Traditional methods of generating visual effects often require users to navigate complex menus and manually adjust numerous parameters, which can be time-consuming and unintuitive for users who desire quick, efficient, and personalized customization of their visual effects.

### SUMMARY

In view of the above issues, a computing system is provided for generating a visual effect. The computing system includes processing circuitry and memory storing an effects generation model and instructions that, when executed, cause the processing circuitry to receive a user query, generate a plurality of action descriptions based on the user query, generate domain-specific language instructions based on the plurality of action descriptions, and select a set of modular subgraphs from a library of a plurality of modular subgraphs based on the domain-specific language instructions. The system assembles the set of modular subgraphs into a package by interconnecting the set of modular subgraphs, and generates the visual effect by executing the package.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the effects generation model of the computing system of FIG. 1.

FIG. 3 illustrates a detailed schematic of a first example of the inputs and outputs of the planner, domain-specific language generator, and modular subgraph selector of FIGS. 1 and 2.

FIG. 4 illustrates a detailed schematic of a user query and a response, including an effect and a natural language response, outputted by the effects generation model in the first example of FIG. 3.

FIG. 5 illustrates a detailed schematic of a second example of the inputs and outputs of the planner, domain-specific language generator, and modular subgraph selector of FIGS. 1 and 2.

FIG. 6 illustrates a detailed schematic of a user query and a response, including an effect and a natural language response, outputted by the effects generation model in the second example of FIG. 5.

FIG. 7 is a flow chart of a method for generating an effect according to an example embodiment of the present disclosure.

FIG. 8 shows an example computing environment of the present disclosure in which the computing system of FIG. 1 may be enacted.

### DETAILED DESCRIPTION

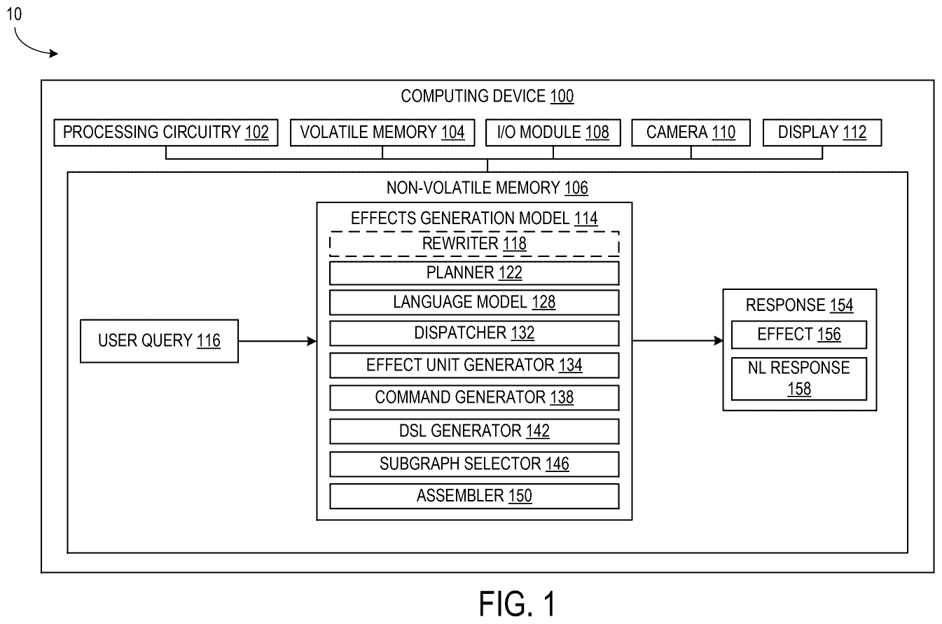

FIG. 1 shows a schematic view of a first example computing system 10 including a computing device 100 for generating an effect 156 using an effects generation model 114. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the effects generation model 114 which is configured to receive a user query 116 and generate a response 154 including the effect 156 and a natural language response 158 based on the user query 116.

The effects generation model 114 may include a rewriter 118 configured to rewrite the user query 116. The effects generation model 114 further includes a planner 122 configured to generate a plurality of action descriptions based on the user query 116, a dispatcher 132 configured to direct the action descriptions to an effect unit generator 134 configured to generate an effect unit based on the action descriptions, and a domain-specific language (DSL) generator 142 configured to generate DSL instructions based on the action descriptions. The effects generation model 114 further includes a command generator 138 configured to generate commands based on the effect units, and a modular subgraph selector 146 configured to select a set of modular subgraphs from a modular subgraph library of a plurality of modular subgraphs based on the DSL instructions. The effects generation model 114 further includes an assembler 150 which is configured to assemble the set of modular subgraphs into a package by interconnecting the set of modular subgraphs, and generate the response 154 including the visual effect 156 and the natural language response 158. The visual effect 156 is generated by executing the assembled package.

The modular subgraphs are modular script graphs that each accomplish independent functions or behaviors, but through the selection and interconnection, can be nested within a main script graph of the effect, to thereby create visual scripting logic to implement the main script graph (including its subgraphs) for the entire effect. The visual scripting logic can be interpreted by a script interpreter. The script interpreter can interpret the visual scripting logic in real time, to enable a user to try out and modify the effect that has just been created, as described below.

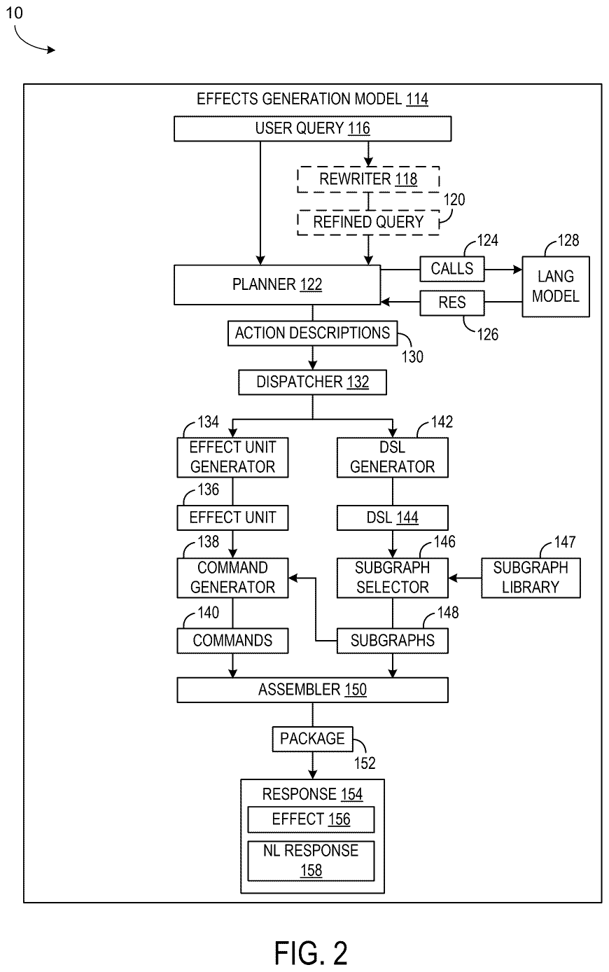

Referring to FIG. 2, the operations of the effects generation model 114 are described in further detail. The effects generation model 114 uses a modular approach to the automated generation of an effect 156 based on the user query 116, leveraging a language model 128 to interpret and guide the effect creation process. The effects generation model 114 receives user query 116, which may mention various aspects of the desired effect. Responsive to receiving the user query 116, the rewriter 118 may rewrite the user query 116 to generate a refined query 120 that may clarify the request of the user. The rewriter 118 may be a language model, for example.

The user query 116 and/or the refined query 120 are fed into the planner 122, which interprets the user query 116 into prompts 124 or calls that guide subsequent content creation through the language model 128. The calls 124 are inputted into the language model 128 to generate responses 126 that are subsequently consolidated by the planner 122 into a plurality of action descriptions 130, which are structured as action templates outlining high-level instructions for executing the desired visual effect 156. The action descriptions 130 may be structured into a predetermined format to include names of events and effect units 136 (including assets or entities) and natural language descriptions of the effect units 136.

The language model 128 may be trained on a diverse database of paired user prompts and action descriptions of visual effects covering a wider range of user queries and visual effects. This training database acts as ground truth, providing the language model 128 with both simple and complex examples of how to translate natural language requests 116 into structured action descriptions 130.

The dispatcher 132 directs the action descriptions 130 to the effect unit generator 134 and the DSL generator 142 to generate effect units 136 and DSL instructions 144, respectively. The effect unit generator 134 and the DSL generator 142 may be configured as language models, for example. Effect units 136 are modules configured to carry specific visual or interactive elements that collectively contribute to the generated effect 156. Effect units 136 are derived from the action descriptions 130 and generated by the effect unit generator 134. Effect units 136 are broadly categorized into assets and entities.

Assets are preconfigured visual or generative elements that define the appearance and properties of the effect. They may include generative effects and textures, for example. Generative effects involve procedural modifications applied to the user's visual representation, such as an “eyebrow eraser,” which dynamically detects and modifies specific facial features. Textures are predefined visual patterns or color schemes, such as “vibrant red hat front view” or intricate makeup designs, which can be directly mapped onto entities or applied as overlays. These assets enable customization and creative variation within the generated visual effect 156.

Entities are interactive or placement-based components that represent discrete visual or functional objects within the visual effect 156. Entities may include physical props, stickers, foreground particles, and interactive controls. For example, physical props may include digital “hats” or “rabbit ears” which dynamically adjust their sizes and orientation to align with the user's head in real-time. A “hand sticker” may be placed on specific areas of the screen or anchored to user-detected movements. Animated sparkles or icons may float in the foreground visual environment. Interactive controls may include functional modules, such as a joystick controller, which enable user inputs to influence the behavior of the visual effect 156.

The command generator 138 translates high-level descriptions of the effect units 136 into specific commands 140 that the assembler 150 can process. The commands 140 define how the effect units 136 behave, interact, and connect with the modular subgraphs 148. The command generator 138 interprets the characteristics and configurations of the effect units 136, and then converts these interpreted characteristic and configurations into the commands 140. The commands 140 may include instantiation commands to create the effect units 136 within the assembled package 152, behavioral commands that define how an effect unit 136 behaves or interacts with other effect units 136, connection commands to establish links between effect units 136 and modular subgraphs 148, and execution flow commands to specify the order of operations or conditional logic for the generated visual effect 156.

The DSL generator 142 generates action descriptions 130 into executable DSL instructions 144, which program and manage events involving the assets and entities generated by the effect unit generator 134. The DSL generator 142 may parse the action descriptions 130 into a series of DSL instructions 144 that programmatically define how the assets and entities should behave to generate the visual effect 156.

The DSL instructions 144 are further translated into modular subgraphs 148, which are modular components representing distinct functionalities for generating the visual effect 156. These modular subgraphs 148 are selected from a modular subgraph library 147 of a plurality of modular subgraphs and connected with each other to form an execution graph that orchestrates the required events to generate the visual effect 156.

The modular subgraph library 147 includes a diverse set of prebuilt modules that handle core functionalities. Such functionalities may include facial expression detection, gesture recognition, object detection and tracking, pose estimation, or color detection, for example.

The modularity and reusability of modular subgraphs 148 allow for efficient execution of complex visual effects 156 while maintaining a high degree of customization. By combining and configuring modular subgraphs 148 from the modular subgraph library 147, new effects 156 may be assembled and deployed without rewriting underlying logic. The domain-specific language acts as an intermediary abstraction layer, bridging the gap between human-readable action descriptions 130 and machine-executable DSL instructions 144, thereby ensuring a robust system 10 for generating interactive visual effects 156.

The final stage involves the assembler 150, which integrates the effect units 136, modular subgraphs 148, and their associated commands 140 into an executable package 152 by interconnecting the set of modular subgraphs 148 and the effect units 136. The assembler 150 ensures that the modular subgraphs 148 generated from the DSL instructions 144 are properly interconnected, organized and optimized for execution on the front-end. The assembler 150 may evaluate dependencies between the modular subgraphs 148 and effect units 136 and add logical connections between modular subgraphs 148 and effect units 136 to enable interactivity and data flow. The assembler 150 bundles the connected modular subgraphs 148 and effect units 136 into the executable package 152, which can be deployed and executed on the front-end system. This package 152 contains the resources, configurations, and connections for rendering the visual effect 156.

The assembler 150 may generate a final output response 154 including not only a preview of the visual effect 156 but also a natural language response 158, which provides a descriptive summary or relative guidance regarding the generated visual effect 156, offering the user a comprehensive overview of their generated visual effect 156. The visual effect 156 may be generated by rendering the visual effect 156 on a user interface on a social media platform, for example.

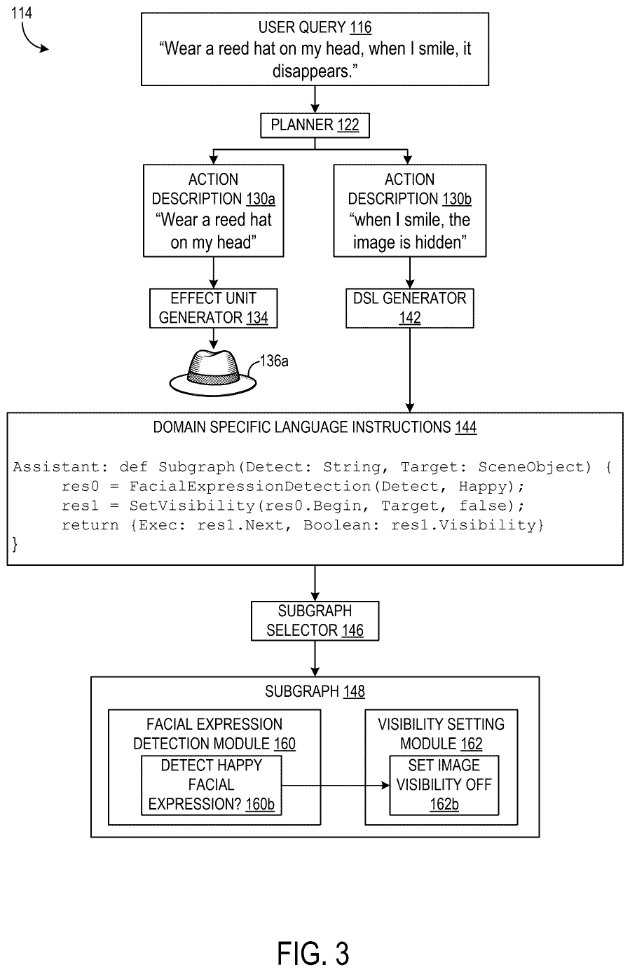

FIG. 3 illustrates the inputs and outputs of the planner 122, the DSL generator 142, and modular subgraph selector 146 of FIGS. 1 and 2 in a first example. In this example, the user inputs a user query 116, “Wear a reed hat on my head, when I smile, it disappears.” In response, the planner 122 generates a first action description 130a, “wear a reed hat on my head”, and a second action description 130b, “when I smile, the image is hidden”. Based on the first action description 130a, the effect unit generator 134 generates an image of a reed hat 136a as an entity and a target scene object.

Based on the second action description 130b, the DSL generator 142 generates DSL instructions 144 which specify a “facial expression detection” function to detect a happy facial expression, and a “set visibility” function for an image that is a target scene object. The modular subgraph selector 146 selects the modular subgraphs 148 in accordance with the DSL instructions 144. The modular subgraphs 148 include a facial expression detection module 160 which includes a conditional logic 160b detecting whether a happy facial expression has been detected. The modular subgraphs 148 also include a visibility setting module 162 for the hat image, which has the “set image visibility off” function 162b which is activated when the facial expression detection module 160 detects a happy facial expression, upon which the visibility of the hat image is turned off. The modular subgraphs 160, 162 are interconnected with each other and with the reed hat image entity 136a to achieve the desired visual effect.

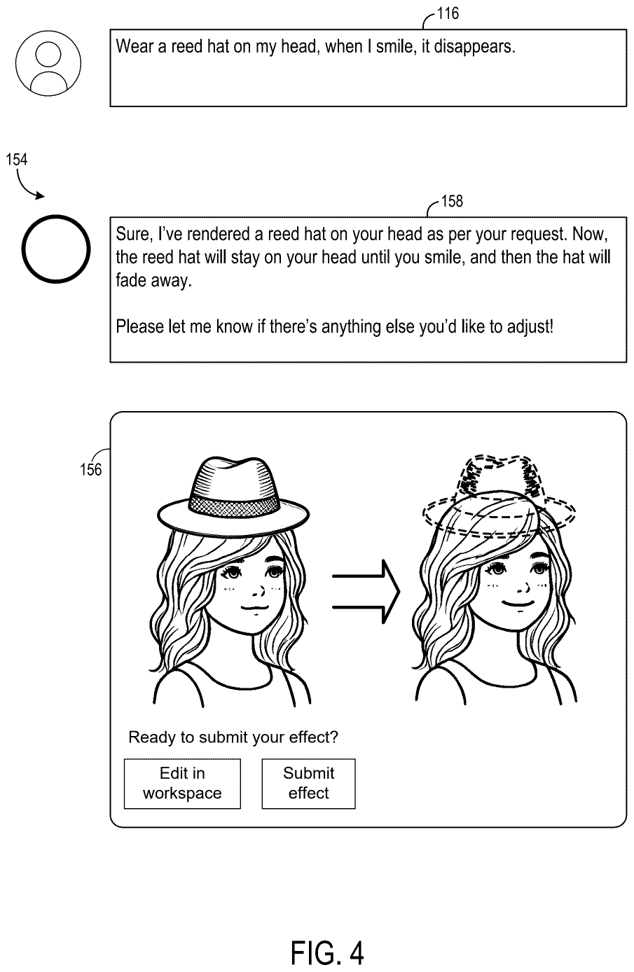

FIG. 4 illustrates the user interface in the first example of FIG. 3, in which the user inputs the user query, “Wear a reed hat on my head, when I smile, it disappears.” The user interface may be displayed on the display 112 of the computing device 100 of FIG. 1. Responsive to receiving the user query 116, the effects generation model 114 generates a response 154 including a preview of the generated effect 156 and a natural language response 158 which provides a descriptive summary or relative guidance regarding the generated visual effect 156, offering the user a comprehensive overview of their generated visual effect 156. In this example, the natural language response 158 explains that the reed hat will stay on the user's head until the user smiles, and then the hat will fade away. The response 154 also includes a prompt asking the user whether the ‘effect’ is ready to be submitted or edited further in the workspace. In other words, the response 154 invites a subsequent user query to modify the generated effect 156.

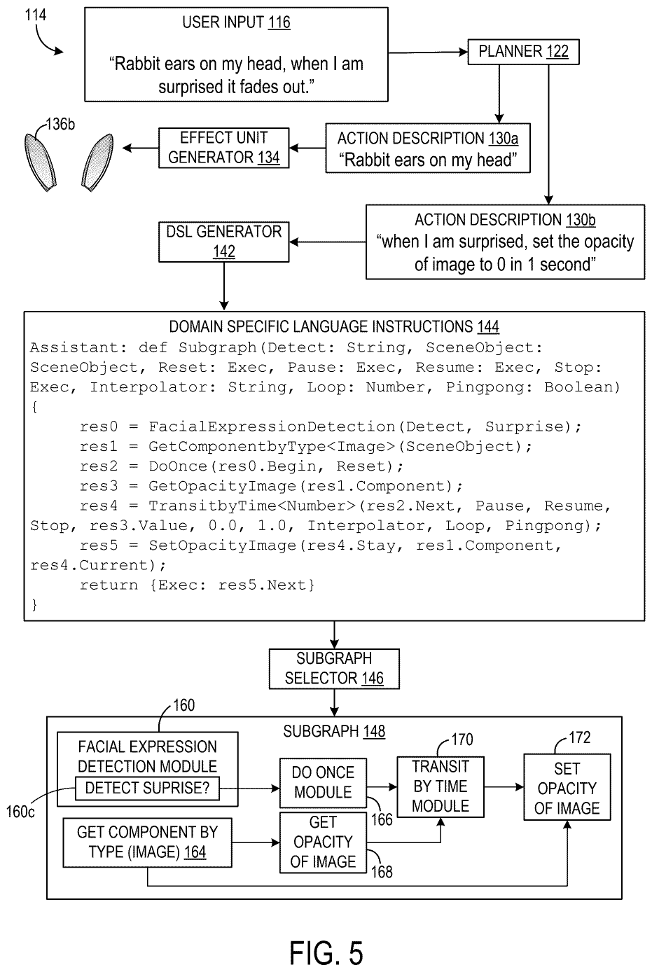

FIG. 5 illustrates the inputs and outputs of the planner 122, the DSL generator 142, and modular subgraph selector 146 of FIGS. 1 and 2 in a second example. In this example, the user inputs a user query 116, “Rabbit ears on my head, when I am surprised it fade out.” In response, the planner 122 generates a first action description 130a, “Rabbit ears on my head”, and a second action description 130b, “when I am surprised, set the opacity of image to 0 in 1 second”. Based on the first action description 130a, the effect unit generator 134 generates an image of rabbit ears 136b as an entity and a target scene object.

Based on the second action description 130b, the DSL generator 142 generates DSL instructions 144 which specify a “facial expression detection” function to detect a happy facial expression, and a “get component by type (image)” function for obtaining the rabbit ears image entity 136b that is a target scene object, a “do once” function for triggering the visual effect based on the facial expression detection, the “get opacity of image” function for fetching the current opacity of the rabbit ears image entity 136b, a “transit-by-time” function for creating a time-based transition to change the opacity of the rabbit ears image entity 136b, and a “set opacity of image” function to update the opacity of the rabbit ears image entity 136b.

The modular subgraph selector 146 selects the modular subgraphs 148 in accordance with the DSL instructions 144. The modular subgraphs 148 include a facial expression detection module 160 which includes a conditional logic 160c for detecting whether a surprised facial expression has been detected. The modular subgraphs 148 also include a “get component by type (image)” module 164 for obtaining the rabbit ears image entity 136b that is a target scene object, a “do once” module 166 for triggering the visual effect based on the facial expression detected by the conditional logic 160c, the “get opacity of image” module 168 for fetching the current opacity of the rabbit ears image entity 136b, a “transit-by-time” module for creating a time-based transition to change the opacity of the rabbit ears image entity 136b, and a “set opacity image” function to update the opacity of the rabbit ears image entity 136b. The modular subgraphs 160, 164, 166, 168, 170, 172 are interconnected with each other and with the rabbit ears image entity 136b to achieve the desired visual effect.

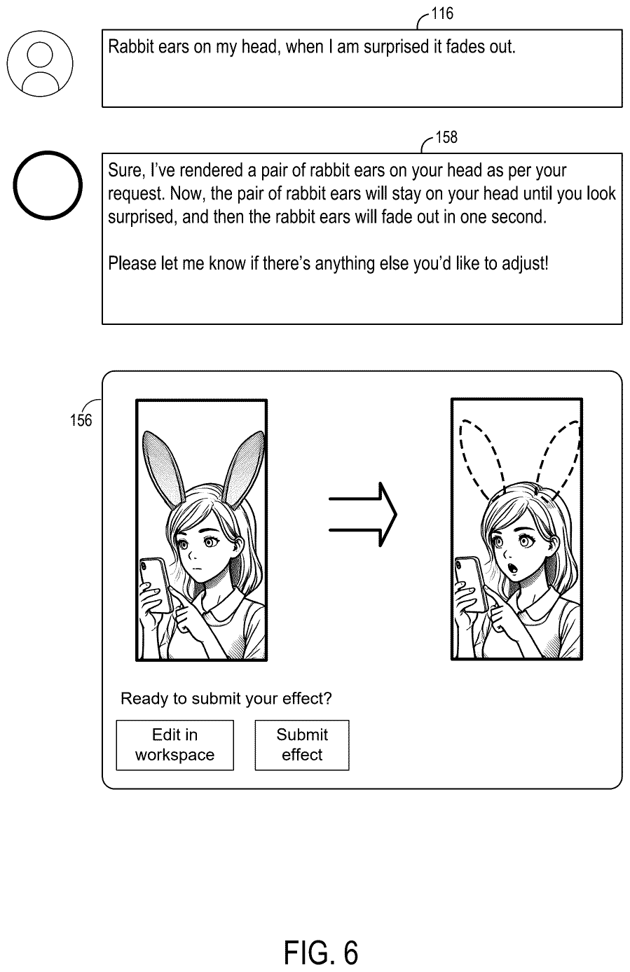

FIG. 6 illustrates the user interface in the second example of FIG. 5, in which the user inputs the user query, “Rabbit ears on my head, when I am surprised it fades out.” The user interface may be displayed on the display 112 of the computing device 100 of FIG. 1. Responsive to receiving the user query 116, the effects generation model 114 generates a response 154 including a preview of the generated effect 156 and a natural language response 158 which provides a descriptive summary or relative guidance regarding the generated visual effect 156, offering the user a comprehensive overview of their generated visual effect 156. In this example, the natural language response 158 explains that the rabbit ears will stay on the user's head until the user looks surprised, and then the rabbit ears will fade out in one second. The response 154 also includes a prompt asking the user whether the ‘effect’ is ready to be submitted or edited further in the workspace. In other words, the response 154 invites a subsequent user query to modify the generated effect 156.

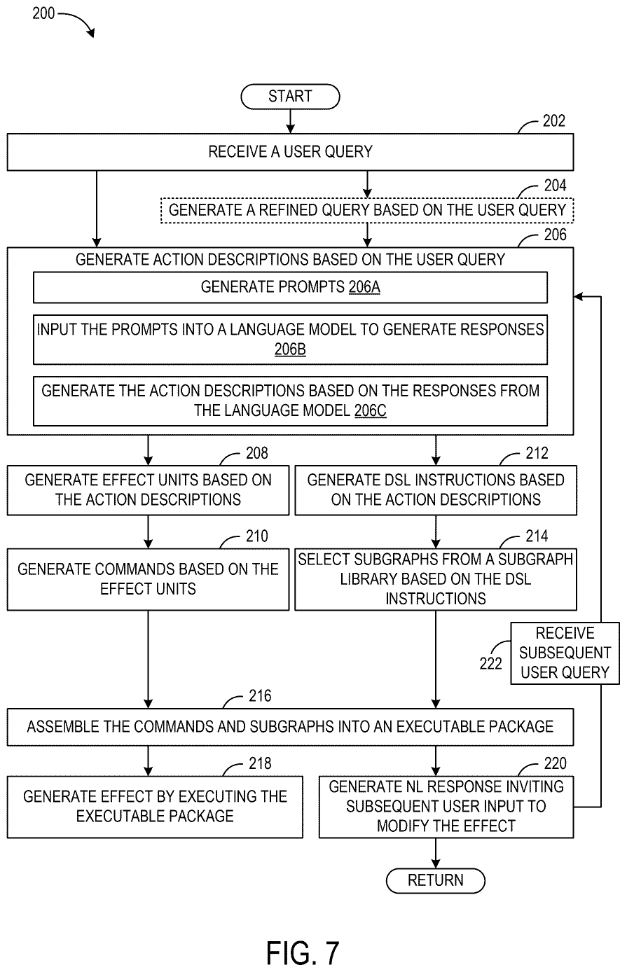

FIG. 7 shows a process flow diagram of an example method 200 for generating a game application. The example method 200 may be executed by the processing circuitry 102 and memory 104 of the computing system 10 of FIG. 1. The example method 200 includes, at step 202, receiving a user query. Method 200 may include step 204 of generating a refined query based on the user query, and step 206 of generating action descriptions based on the refined query. At step 206, the method 200 includes generating action descriptions based on the user query. Step 206 may include step 206A of generating prompts, step 206B of inputting the prompts into a language model to generate responses, and step 206C of generating the action descriptions based on the responses from the language model.

The method 200 includes step 208 of generating effect units based on the action descriptions, and step 210 of generating commands based on the effect units. The method 200 also includes step 212 of generating DSL instructions based on the action descriptions, and step 214 of selecting modular subgraphs from a modular subgraph library based on the DSL instructions.

At step 216, the method 200 includes assembling the commands and the modular subgraphs into an executable package. At step 218, the method 200 includes generating the effect by executing the executable package, and at step 220, generating a natural language response inviting a subsequent user query to modify the effect. When, at step 222, a subsequent user query is received, the method 200 proceeds to step 206 of generating action descriptions based on the subsequent user query.

As described throughout herein, by leveraging language models to enable users to specify, customize, and refine their visual effects using natural language prompts, visual effects creation may be made more accessible to users. Users may achieve highly tailored visual effects without the complexity associated with traditional customization methods. The above-described system and method not only simplify the process of creating visual effects, but also empower users to achieve professional-quality results in a fraction of the time. The system and method described herein may be broadly applied not only for enhancing user-generated content in social media, but also for enabling innovative solutions in entertainment, education, healthcare, and beyond.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

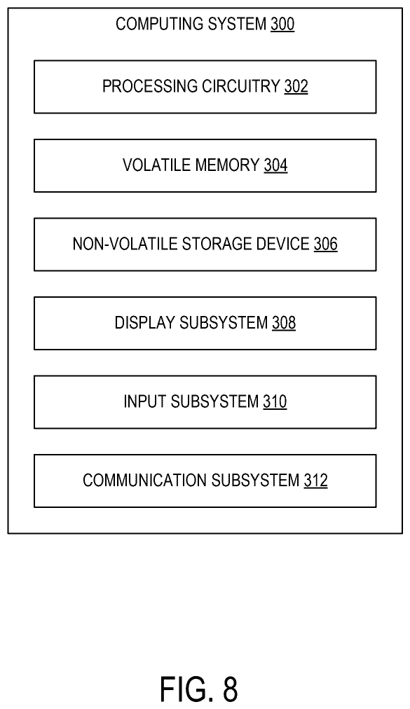

FIG. 8 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system for generating a visual effect, the computing system comprising processing circuitry and memory storing an effects generation model and instructions that, when executed, causes the processing circuitry to receive a user query, generate a plurality of action descriptions based on the user query, generate domain-specific language instructions based on the plurality of action descriptions, select a set of modular subgraphs from a library of a plurality of modular subgraphs based on the domain-specific language instructions, assemble the set of modular subgraphs into a package by interconnecting the set of modular subgraphs, and generate the visual effect by executing the package. In this aspect, additionally or alternatively, the plurality of action descriptions may be generated by generating one or more prompts, inputting the one or more prompts into a language model to generate one or more responses, and generating the plurality of action descriptions based on the one or more responses. In this aspect, additionally or alternatively, the processing circuitry may be further configured to generate effect units based on the plurality of action descriptions, and assemble the set of modular subgraphs and the effect units into the package by interconnecting the set of modular subgraphs and the effect units. In this aspect, additionally or alternatively, the effect units may comprise assets and entities, the assets may include textures, and the entities may include objects. In this aspect, additionally or alternatively, the processing circuitry may be further configured to generate connection commands to establish links between the effect units and the modular subgraphs. In this aspect, additionally or alternatively, the action descriptions may include names of the effect units and natural language descriptions of the effect units. In this aspect, additionally or alternatively, modular subgraphs may be modular script graphs that each accomplish independent functions or behaviors. In this aspect, additionally or alternatively, the visual effect may be generated by rendering the visual effect on a user interface on a social media platform. In this aspect, additionally or alternatively, the modular subgraphs may handle functionalities including at least one of facial expression detection, gesture recognition, object detection and tracking, pose estimation, or color detection. In this aspect, additionally or alternatively, the processing circuitry may be configured to further generate a natural language response inviting a subsequent user query to modify the visual effect.

Another aspect provides a computing method for generating a visual effect, the computing method comprising receiving a user query, generating a plurality of action descriptions based on the user query, generating domain-specific language instructions based on the plurality of action descriptions, selecting a set of modular subgraphs from a library of a plurality of modular subgraphs based on the domain-specific language instructions, assembling the set of modular subgraphs into a package by interconnecting the set of modular subgraphs, and generating the visual effect by executing the package. In this aspect, additionally or alternatively, the plurality of action descriptions may be generated by generating one or more prompts, inputting the one or more prompts into a language model to generate one or more responses, and generating the plurality of action descriptions based on the one or more responses. In this aspect, additionally or alternatively, the computing method may further comprise generating effect units based on the plurality of action descriptions, and assembling the set of modular subgraphs and the effect units into the package by interconnecting the set of modular subgraphs and the effect units. In this aspect, additionally or alternatively, the effect units may comprise assets and entities, the assets may include textures, and the entities may include objects. In this aspect, additionally or alternatively, the computing method may further comprise generating connection commands to establish links between the effect units and the modular subgraphs. In this aspect, additionally or alternatively, the action descriptions may include names of the effect units and natural language descriptions of the effect units. In this aspect, additionally or alternatively, modular subgraphs may be modular script graphs that each accomplish independent functions or behaviors. In this aspect, additionally or alternatively, the visual effect may be generated by rendering the visual effect on a user interface on a social media platform. In this aspect, additionally or alternatively, the modular subgraphs may handle functionalities including at least one of facial expression detection, gesture recognition, object detection and tracking, pose estimation, or color detection.

Another aspect provides a computing system for generating a visual effect, the computing system comprising processing circuitry and memory storing an effects generation model and instructions that, when executed, causes the processing circuitry to receive a user query, select a set of modular subgraphs from a library of a plurality of modular subgraphs based on the user query, assemble the set of modular subgraphs into a package by interconnecting the set of modular subgraphs, and generate the visual effect by executing the package, wherein the modular subgraphs handle functionalities including at least one of facial expression detection, gesture recognition, object detection and tracking, pose estimation, or color detection.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a visual effect, the computing system comprising:
processing circuitry and memory storing an effects generation model and instructions that, when executed, causes the processing circuitry to:
receive a user query;
generate a plurality of action descriptions based on the user query;
generate domain-specific language instructions based on the plurality of action descriptions;
select a set of modular subgraphs from a library of a plurality of modular subgraphs based on the domain-specific language instructions;
assemble the set of modular subgraphs into a package by interconnecting the set of modular subgraphs; and
generate the visual effect by executing the package.

2. The computing system of claim 1, wherein the plurality of action descriptions are generated by generating one or more prompts, inputting the one or more prompts into a language model to generate one or more responses, and generating the plurality of action descriptions based on the one or more responses.

3. The computing system of claim 1, wherein the processing circuitry is further configured to:
generate effect units based on the plurality of action descriptions; and
assemble the set of modular subgraphs and the effect units into the package by interconnecting the set of modular subgraphs and the effect units.

4. The computing system of claim 3, wherein
the effect units comprise assets and entities;
the assets include textures; and
the entities include objects.

5. The computing system of claim 3, wherein the processing circuitry is further configured to:
generate connection commands to establish links between the effect units and the modular subgraphs.

6. The computing system of claim 3, wherein the action descriptions include names of the effect units and natural language descriptions of the effect units.

7. The computing system of claim 1, wherein modular subgraphs are modular script graphs that each accomplish independent functions or behaviors.

8. The computing system of claim 1, wherein the visual effect is generated by rendering the visual effect on a user interface on a social media platform.

9. The computing system of claim 1, wherein the modular subgraphs handle functionalities including at least one of facial expression detection, gesture recognition, object detection and tracking, pose estimation, or color detection.

10. The computing system of claim 1, wherein the processing circuitry is configured to further generate a natural language response inviting a subsequent user query to modify the visual effect.

11. A computing method for generating a visual effect, the computing method comprising:
receiving a user query;
generating a plurality of action descriptions based on the user query;
generating domain-specific language instructions based on the plurality of action descriptions;
selecting a set of modular subgraphs from a library of a plurality of modular subgraphs based on the domain-specific language instructions;
assembling the set of modular subgraphs into a package by interconnecting the set of modular subgraphs; and
generating the visual effect by executing the package.

12. The computing method of claim 11, wherein the plurality of action descriptions are generated by generating one or more prompts, inputting the one or more prompts into a language model to generate one or more responses, and generating the plurality of action descriptions based on the one or more responses.

13. The computing method of claim 11, further comprising:
generating effect units based on the plurality of action descriptions; and
assembling the set of modular subgraphs and the effect units into the package by interconnecting the set of modular subgraphs and the effect units.

14. The computing method of claim 13, wherein
the effect units comprise assets and entities;
the assets include textures; and
the entities include objects.

15. The computing method of claim 13, further comprising: generating connection commands to establish links between the effect units and the modular subgraphs.

16. The computing method of claim 13, wherein the action descriptions include names of the effect units and natural language descriptions of the effect units.

17. The computing method of claim 11, wherein modular subgraphs are modular script graphs that each accomplish independent functions or behaviors.

18. The computing method of claim 11, wherein the visual effect is generated by rendering the visual effect on a user interface on a social media platform.

19. The computing method of claim 11, wherein the modular subgraphs handle functionalities including at least one of facial expression detection, gesture recognition, object detection and tracking, pose estimation, or color detection.

20. A computing system for generating a visual effect, the computing system comprising:
processing circuitry and memory storing an effects generation model and instructions that, when executed, causes the processing circuitry to:
receive a user query;
select a set of modular subgraphs from a library of a plurality of modular subgraphs based on the user query;
assemble the set of modular subgraphs into a package by interconnecting the set of modular subgraphs; and
generate the visual effect by executing the package, wherein
the modular subgraphs handle functionalities including at least one of facial expression detection, gesture recognition, object detection and tracking, pose estimation, or color detection.
